(19) United States
(12) Patent Application Publication
(10) Pub. No.: US 2011/0095543 A1
(43) Pub. Date: Apr. 28, 2011

(54) EQUIPMENT OF CONTINUING PNEUMATIC ELECTRIC IMPULSE

(75) Inventor: Marcos Volpe Filho, Sao Paulo (BR)

(73) Assignee: FERNANDO AUGUSTO PANCHECO DA CRUZ, VILA SANTA CRUZ, ITATIBA (BR)

(21) Appl. No.: 12/673,209

(22) PCT Filed: Aug. 22, 2008
(86) PCT No.: PCT/BR08/00252

§ 371 Date: Feb. 12, 2010

(30) Foreign Application Priority Data
Aug. 23, 2007 (BR) MU8701775-0

(51) Int. Cl. H02K 7/18; F03B 17/04

(52) U.S. Cl. 290/1 R; 415/916

(57) ABSTRACT

Patent of utility model for an EQUIPMENT OF CONTINUING PNEUMATIC ELECTRIC IMPULSE composed of vacuum chamber with metallic oval structure 1, where two generators 10 and 11 are coupled and fastened, through the axle 9 regarding the generator 10, with electric exciter 14 and pneumatic piston 19 that commands the equipment start-up; through generator 11 with electric exciter 15, feeding an electric motor 12 with pneumatic command 20 and field coil 22 performing electric disconnection of the motor set and generator 18, providing absolute vacuum 13, giving command in pneumatic piston 19 and electric motor 12, generating electric power. Through the electric-magnetic coupling 5, (FIG. 2) the vacuum pump 3 is located producing vacuum as in the first stage of the pneumatic turbine 2 with second stage in the turbine 6 generating high pressure for start-up, and turbocompressor of compressed air 4, feeding the reservoir of the tubular structure 7 with fastening bracket 17 and relief valve with calibration spout 16 and transportation handle dovetail 8.

### BACKGROUND OF THE INVENTION

The present patent of utility model has as the purpose a model of EQUIPMENT OF CONTINUING PNEUMATIC ELECTRIC IMPULSE for use at areas of difficult access to the electric line and of easy transportation, and which original construction was given to, viewing to improve its utilization and efficiency as compared with the existing similar ones.

Ways for generation of energy are already known, such as: motor-generators put in motion by: Gasoline, Alcohol, Diesel, Gas. Nuclear, Solar, Hydroelectric Energy Generators and also the energy produced by wind generators.

### BRIEF SUMMARY OF THE INVENTION

In spite of the broad utilization of those types of energies, some inconveniences can be attributed to them as for example, in the case of the motor-generated energy that, due to the fact that the user must regularly fuel the equipment, there is some cost of refueling, as well as there is also the discharging of polluting gases to the atmosphere, and other aforementioned energy types are utilized in projects of high cost and they are of difficult access and transportation for the user.

Taking into account those problems, and with the purpose of overcoming them, it was developed the layout of an equipment of continuing pneumatic electric impulse, that is the subject matter of the present patent, which consists of an alternative energy system through a pneumatic system.

That way for construction of the equipment solves the inconveniences as pointed out, considering that it provides a clean energy, working at any gravitational location, being of easy transportation, and meeting the needs where there are areas of difficult access to the electric lines, as well as to energy production plants, due to the fact of not existing the need of utilization of combustibles such as: Gasoline, Alcohol, Diesel, Gas that are pollutants for the atmosphere, thus the user will not have to fuel or refuel its equipment and, consequently, it will help the ecosystem.

### BRIEF DESCRIPTION OF THE DRAWINGS

The attached drawings show the layout of an equipment of continuing pneumatic electric impulse, being the subject matter of the present patent, on which.

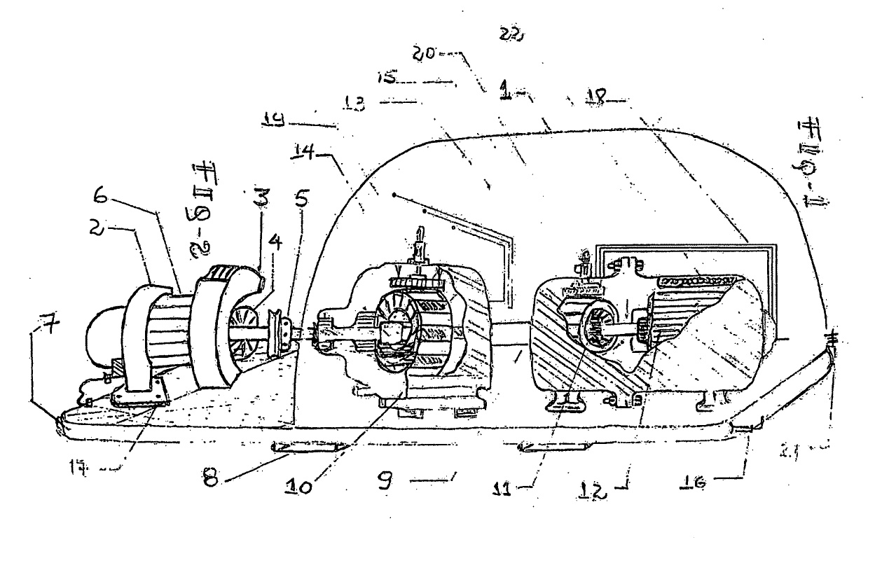

The FIG. 1 shows, as a cutting view, the vacuum chamber with two generators and an electric motor;

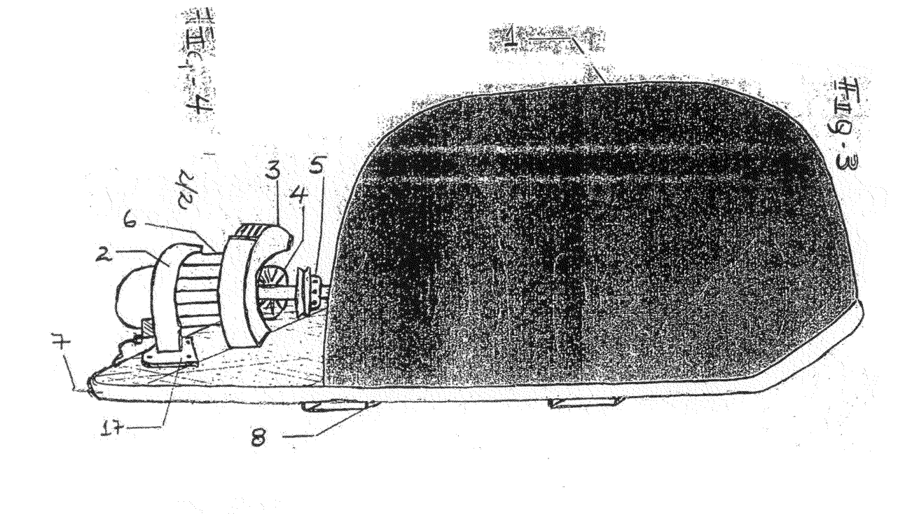

The FIG. 2 shows the turbine with its coupling between the axle ends;

The FIG. 3 shows the closed vacuum chamber;

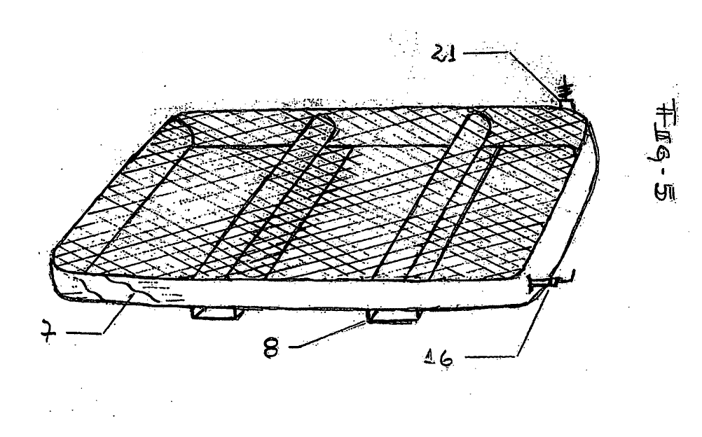

The FIG. 4 shows the turbine externally coupled to the axle;

The FIG. 5 shows the tubular structure and the compressed air reservoir;

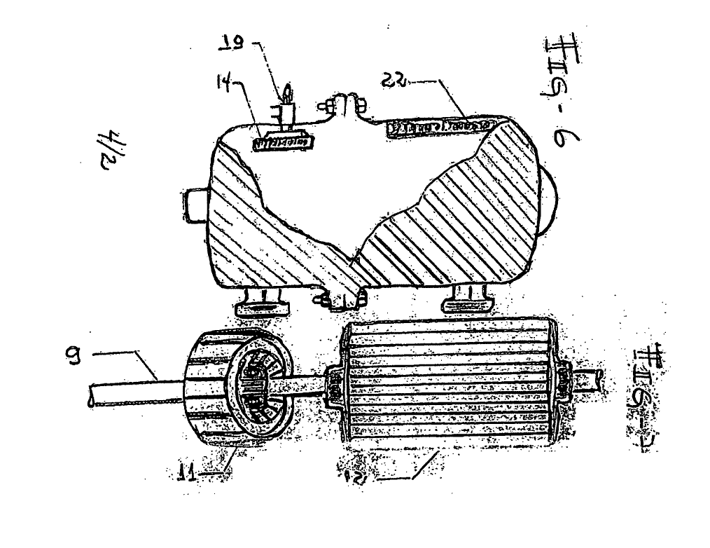

The FIG. 6 shows the cutting view of the electric motor carcass with the magnetic field coils;

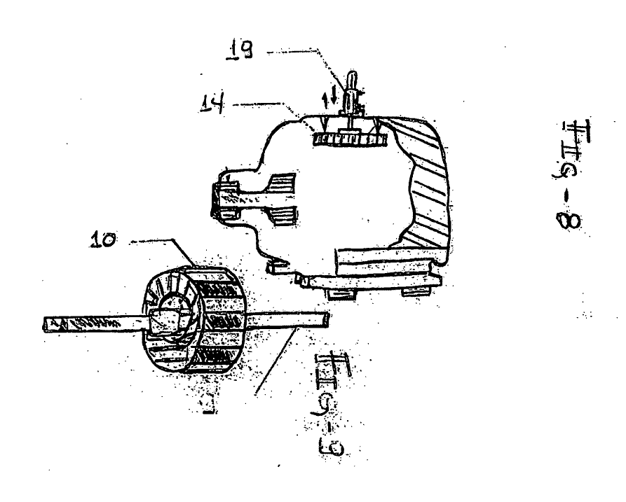

The FIG. 7 shows the axle with the motor and generator inductors;

The FIG. 8 shows the cutting view of the generator carcass with field coil and piston with pneumatic command;

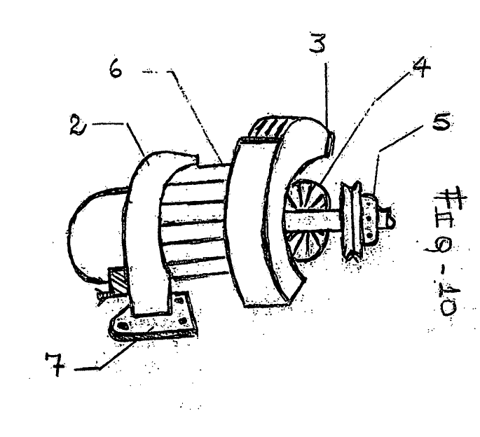

The FIG. 9 shows the axle with the inductor of the generator;

The FIG. 10 shows the turbine being uncoupled from the axle with magnetic-electric coupling.

### DETAILED DESCRIPTION OF THE PREFERRED EMBODIMENTS

In conformity with what is shown on the figures as listed above, the model of continuing pneumatic electric impulse equipment, being the subject matter of the present patent, consists of vacuum chamber with oval metallic structure 1, where two generators 10 and 11 are coupled and fastened, through the axle 9 the generator 10 with electric exciter 14 and pneumatic piston 19 that commands the start-up of the equipment, through the generator 11 with electric exciter 15 that feeds the electric motor 12 with pneumatic command 20 and field coil 22 performing the electric closing of the motor and generator set 18 that, on its side, it provides an absolute vacuum 13, giving command to pneumatic piston 19 and electric motor 12, generating the electric power.

Through the magnetic-electric coupling 5, (FIG. 2), the vacuum bomb is located 3, which produces vacuum, in the first stage of the pneumatic turbine 2 with second stage in the turbine 6 producing high pressure for the start-up, and turbocompressor of compressed air 4 that feeds the reservoir of the tubular structure 7 with fastening bracket 17 and relief valve 2 with calibration spout 16 and transportation handle dovetail 8.

What is claimed is:

1. “EQUIPMENT OF CONTINUING PNEUMATIC ELECTRIC IMPULSE” composed of vacuum chamber with oval metallic structure (1), fastened by two generators (10), with electric exciter (14) and piston of pneumatic command (19) for start-up of the equipment, it feeds electric motor (12) with field coil (22) producing the electric closing through the generator (18) providing absolute vacuum (13) giving command to the pneumatic piston of the generator (11) and to the electric motor (20) that passes by the electric exciter (11) through the axle (9) and generator (10) with electric exciter (14) and pneumatic piston (19) commanding the equipment start-up through generator (11) with electric exciter (15) that feeds electric motor (12) with pneumatic command (20) and field coil (22) performing the electric closing of the motor and generator set (18) providing an absolute vacuum (13), commanding pneumatic piston (19) and electric motor (12), generating the electric power. Through the magnetic-electric coupling, (FIG. 2) the vacuum bomb is located (3) in the first stage of the pneumatic turbine (2) with second stage in the turbine (6) generating high pressure for start-up, and turbocompressor of compressed air (4) that feeds the reservoir of the tubular structure (7) with fastening bracket (17) with relief valve (21), calibration spout (16) and transportation handle dovetail (8).
